(19) United States
(12) Patent Application Publication
(10) Pub. No.: US 2003/0228447 A1
(43) Pub. Date: Dec. 11, 2003

(54) Security paper/paperboard and a method of producing security paper/paperboard

(76) Inventors: Philippe Gilbert Letzelter, Iggesund (SE); Anna Margareta Lundh, Hudiksvall (SE)

Correspondence Address: SUGHRUE MION, PLLC, 2100 PENNSYLVANIA AVENUE, N.W., WASHINGTON, DC, 20037, US

(21) Appl. No.: 10/311,802

(22) PCT Filed: Jun. 6, 2002
(86) PCT No.: PCT/SE01/01398

(51) Int. Cl. B32B 3/00

(52) U.S. Cl. 428/172

(57) ABSTRACT

The present invention relates to security paper and security paperboard that comprises respectively base paper and base paperboard having one or several layers of pulp fibre, plus a surface treatment layer on at least one side of the base paper and base paperboard, wherein said layer is congruent with said base paper and base paperboard, and wherein at least one layer forms part of at least one local deviation in the form of a distinctive mark. The invention is characterised in that the local deviation includes locally compressed material plus a local surface treatment layer whose thickness exceeds the thickness of the corresponding surrounding and outwardly lying surface treatment layer.

The present invention also relates to a method of manufacturing security paper and security paperboard.

### TECHNICAL FIELD

The invention relates to security paper/paperboard comprised of a base material and one or more surface treatment layers on one or both sides of the base material. The base material may be paper or preferably paperboard.

The paper is normally comprised of a layer of pulp fibre, although it may alternatively comprise several layers. The paper is of the kind that has a pronounced thickness and stability, and will preferably have a weight per unit area, or grammage, greater than 80 g/m² and by all means two times this weight.

The paperboard is comprised of one or usually several layers of pulp fibre, such as four or five layers. When the pulp in all fibre layers is of one and the same type of pulp, usually chemical pulp, the product is designated homogenous paperboard, whereas if the pulp in at lest one of said fibre layers is of a type different than the type of pulp in the remaining fibre layers, the product is designated folding boxboard. Such paperboard includes fibre layers, normally of chemical pulp, and fibre layers of mechanical pulp for example. The weight per unit area, or grammage, of the board may vary within very wide limits, such as limits ranging from 140 g/m² to 600 g/m².

By surface treatment layer is meant primarily a coating layer. This layer is derived from varying types of coating slip. As previously mentioned, the base material may include from one coating layer to several coating layers and the weights of the total coating layers may vary within relatively wide limits, for instance from 5 g/m² to 70 g/m².

The invention also relates to a method of manufacturing security paper/paperboard.

### BACKGROUND ART

Many uncoated papers show so-called watermarks, e.g. in the form of the manufacturer's company name or some other distinctive symbol. The watermark is normally obtained by patterning a wire in the paper machine, for instance the wire located on the dandy roll. The paper watermark is clearly visible when the paper is held up to a light source, for instance daylight entering a room through a window. This type of paper is a form of security paper.

There are different ways of marking a finished paper, so as to incorporate in the paper something that resembles a watermark.

According to the International (PCT) Application WO 94/07694, a chemical is applied to the paper so that the paper will become transparent on those surfaces onto which the chemical is applied. The chemical in question is applied by transferring, via a number of rollers, a solution of the chemical to a marking device mounted on a roll mounted in the immediate vicinity of another roll, wherewith the chemical solution is transferred from the marking device to the paper as the paper passes through the nip defined between said two rolls. This chemical watermarking of paper is carried out conveniently in a printing press and said treatment is effected either immediately prior to or immediately subsequent to the actual printing process.

According to the German Patent Specification 3 718 452, a number of distinctive marks are embossed mechanically in the paper, and it is stated in the specification that the paper becomes transparent at the embossing locations. That is carried out by providing a roll with a plurality of patterned projections. Anvils are mounted on a shaft in a number that corresponds to the number of projections and at a small distance from said projections and with a width that covers respective projections. The paper is introduced into the gap between the projections and the anvils, and because the narrowest part of said gap is slightly narrower than the thickness of the paper, the pattern of the projections will be embossed into the paper.

The need of surface treated paper, primarily coated paper, has increased steadily in recent years. If a base paper showing watermarks in accordance with the aforegoing is coated, the watermarks will be covered and hidden by the coating layer and the paper will cease to be readily identified. In the Swedish Patent Specification 505 397(9503958-2) a paper that can be readily identified, despite being surface treated, e.g. coated, is presented. The paper concerned in this case is a security paper that is comprised of base paper that has been provided with a surface treatment layer on at least one side of the paper, and the paper is characterised in that the layer thickness clearly deviates locally from the layer thickness of the remaining dominative paper surface, said local deviation forming the distinctive mark on the paper. The paper in question is comprised of a base paper which is uniform across the whole of its surface, whereas the surface treatment layer, for instance the coating layer, presents surfaces that have the form of distinctive marks where the layer thickness is either greater or smaller (or both in separate positions) than the thickness of the layer on the remaining surface of the paper. The distinguishing ability of the security paper is concerned with light and irradiation. The distinctive marks in the paper are evident most clearly when the paper is placed above or directly towards a light source, for instance a light bulb or lamp. When the thickness of the local layer is greater than the thickness of the layer of the dominative surface of the paper, the distinctive marks appear in a darker colour than the remainder of the paper, whereas when the local layer thickness is smaller than the thickness of the layer on the dominative surface of the paper, the distinctive marks appear as a lighter colour than the colour of the paper in general.

In the European Patent Application 0 687 771 a security paper which includes paper that has a high weight per unit area and that is also designated board and possibly paperboard or cardboard is shown. According to this patent application, an advanced, surface-discernible, profiled pattern can be obtained on the material, by passing a web of said material through the nip defined between a patterned roll and a counter-pressure roll, immediately downstream of the press section in the paper machine. The material web has at this location a moisture content that enables it to readily take-up the pattern, which is then fixated in contact with the hot drying cylinders in said machine. This pattern becomes more durable, sharper, and may be made more advanced than when the pattern is applied to material that has already been dried.

### DISCLOSURE OF THE INVENTION

Technical Problems

There is a need for comparatively inexpensive, surface-treated security paper and comparatively inexpensive surface-treated security paperboard, not least when, e.g. paperboard is used for packaging diverse branded products. There is also a need of minimising, and preferably eliminating, turnaround time in the transition from the manufacture of other products to the manufacture of said security products, and vice versa on a paper/paperboard machine.

The Solution

The present invention satisfies these needs and solves said problems, and relates partly to security paper/paperboard that includes one or more layers of pulp fibre forming a base paper/paperboard together with one or more surface treatment layers congruent with the base paper/paperboard on at least on one side thereof, of which layers at least one is part of at least one local deviation forming a distinctive mark in the paper/paperboard, wherein the invention is characterised in that the local deviation includes locally compressed material together with a local surface treatment layer whose thickness exceeds the thickness of the corresponding surface treatment layers located around and outside said local layer and relates partly to a method of manufacturing these products.

The sole distinctive mark or, normally, the several distinctive marks, has/have the form of a company name and/or a company logotype and/or a trademark and/or some other special symbol. The extent to which the surface of the paper or board is covered by the distinctive marks will vary in accordance with requirements, although it will be, for instance, at most 10% and normally at most 5%.

The base paper may be comprised of any paper that has the aforesaid weight per unit area or grammage. The major part of the paper is comprised of pulp fibres including pulp fibres that have been produced in a mechanical, chemimechanical and chemical way. The lignocellulose material from which the pulp has been produced may be any known lignocellulose material, including softwood and hardwood. A mixture of different pulp fibres forms a typical pulp furnish. The pulps may be unbleached, semibleached or fully bleached, with the latter pulp being the dominating pulp. Recycled fibres may form the base in the paper, either completely or partially. Also an addition of synthetic fibres is possible. The base paper includes one or more known paper chemicals, in addition to pulp fibres. Some base papers contain one or more fillers.

What has been said above also applies generally to the base paperboard. Although paperboard is available that includes only one pulp fibre layer, it is most usual that the paperboard will include several fibre layers, for instance three, four or five such layers. In high quality paperboard there is often used in the various layers a fully bleached chemical pulp, such as sulphate pulp produced form both hardwood and softwood, either in a pure state or in mixture. One or more of the midway layers will typically consist, either completely or partially, of pulped broke i.e. pulp that is prepared, for instance, when cuttings from the paperboard web are slushed in a pulper or slushier. As earlier mentioned, the aforedescribed paperboard is designated homogenous paperboard. Another type of paperboard is folding boxboard, where at lest one of the layers is comprised of fibres of some type of mechanical pulp whereas the remaining layers are normally comprised of fully bleached chemical pulp. Exclusively recycled fibres are used in one or more layers of a certain type of paperboard. A large number of paperboard types exist, and all of these types may form part of the inventive security paperboard.

Both the base paper and the base paperboard may be coated on one or both sides with a surface size derived from a chemical mixture, typically with starch and/or some synthetic glue as the main ingredient. The paper/paperboard may also include an agent, which renders the paper/paperboard hydrophobic, referred to hereinafter as a hydrophobising agent.

The surface treatment layer or layers will primarily consist of a coating layer. The starting material used may be any coating slip whatsoever. Such slips typically include a large number of chemicals, with binding agent and pigment as the dominating chemicals. The slip may also include an optical whitener. Surface size that has been supplemented with pigment is included in the term coating slip as used in this document.

In its simplest form, the inventive security product is comprised of a base paper or base paperboard, optionally provided with a surface sizing layer, which has been provided, through the medium of an embossing operation, with at least one compressed surface such as to form a distinctive mark, for example a logotype, and the whole of the material is covered with a coating layer that has one and the same thickness with the exception of the thickness over the distinctive mark, where the layer has a greater thickness. This difference in layer thickness is explained by the fact that the embossed surface, i.e. the compressed surface, constitutes a sunken or depressed surface in the material, and when coating slip is then applied to the whole of the surface of the material, in accordance with any known coating technique, more slip will remain in the depression or depressions than that carried by the remainder of the material. This difference in the amount of coating slip retained results in a local increase in thickness of the coating layer after the slip has dried and formed a finished layer.

When such a paper and such a paperboard is directed towards a lamp or towards a window in daylight, the distinctive mark will show in a darker colour than the remainder of the material. When such a paper or such a paperboard is held in one hand and angled, e.g. tilted relative to a light source there will be seen a difference in the lustre or sheen of the distinctive mark or marks relative to the paper or board in general. This variation in lustre will remain, even after printing ink has been applied to the material.

According to one preferred embodiment of the invention, the increased thickness of the local coating layer shall not fully compensate for the reduced thickness of the underlying material caused by said compression. The reason for this is that a slight sinking of the material at the distinctive mark surfaces contributes towards making these surfaces visible on the one hand, and enabling the surfaces to be discerned by touch on the other hand, i.e. by moving the fingers over the material.

If for some special reason it is desired that the security paper or security paperboard shall be totally smooth and even, in the absence of any depressed regions in the material, for instance when the material is to receive some special print, the increased thickness of the local coating layer may be caused to fully compensate for the reduced thickness of underlying material caused by said compression.

The aforedescribed products may be provided with at least one further coating layer. In this case, at least the undermost coating layer has a locally increased thickness. If the product has, for instance, two coating layers, it is, of course, fully conceivable for both coating layers to have a locally increased thickness. It is natural for the difference in thickness to be greater in the undermost coating layer than in the upper coating layer.

The thickness of the coating layer or layers in the distinctive areas of the paper/paperboard is determined by several factors, such as the depth of embossment in the material, the coating technique used, the amount of coating slip applied to each layer, the number of layers included, and so on.

According to another embodiment of the invention, the starting material prior to embossment, and therefore also the locally compressed material, is comprised of base paper or base paperboard, optionally plus a surface size layer, and a first coating layer, said material being covered in its entirety with a further coating layer of one and the same thickness, with the exception of the aforesaid distinctive mark or marks where the layer thickness is greater.

Analogously with the aforegoing, the paper or paperboard may include at least two further coating layers, of which at least the lowermost of said further coating layer has a locally increased thickness.

When viewing, for instance, the security paperboard in cross-section taken in a region of the distinctive mark and in the proximity of said mark it is normal that the depression in the base material will have a generally rectangular shape. The deviation from the strict rectangular shape is due to the fact that the transitions between the three sides of the depression are not sharp, i.e. perpendicular, but are rounded to a greater or lesser extent. The bottom surface of the depression is generally flat and parallel with the bottom delimiting surface of the paperboard in normal cases. However, it is quite feasible, and even advisable, to allow said bottom surface to slope in relation to the lower delimiting surface of the paperboard. The bottom surface may also be V-shaped and it can also be profiled in some other ways. The profiled bottom surface is covered by at least one coating layer, which will then also be profiled to some degree. This enables the paperboard to be provided with a distinctive mark that is discerned as being three-dimensional to some degree.

Hitherto, solely products that have at least one coating layer on one side of the product have been described. Naturally, the other side of the product may also be provided with at least one coating layer. When, for instance, the inventive security paperboard is intended for packaging purposes, i.e. for enclosing diverse products or goods, a conventional coating layer on the inside of the paperboard (which is not absolutely necessary) will suffice for instance. When the inventive security paperboard is intended for use with products where both sides of the board are exposed, it is both possible and suitable to provide both of these sides with distinctive marks of the aforedescribed kind.

As before mentioned, the coating layer may include an optical whitener. Since this coating layer is thicker in those regions of the surface that carry the distinctive mark(s), more optical whitener will be present in these regions than in the remainder of the material. When the material is placed above a UV-lamp (ultraviolet lamp) or better still if the material is illuminated by such a lamp from one side or from above, the surfaces bearing the distinctive mark will be clearly discernible and with a particular brightness or white lustre. The optical whitener may be supplied to the material per se, (as described in more detail hereinafter), in the form of an extremely thin film which collects in the depressions forming part of the distinctive mark regions in the material, in addition to being supplied via the coating slip.

The security paperboard and security paper according to the invention can thus be readily identified, essentially with the aid of light-daylight and/or artificial light from a standard lamp and/or ultraviolet light.

The invention also relates to a method of producing security paper/paperboard, wherein a coating slip is applied congruently to a travelling paper/paperboard web, possibly after applying surface size, in at least one stage, characterised in that the travelling paper/paperboard web is caused to pass between an embossing roll and a counter-pressure roll which together form an embossing unit, in any position whatsoever prior to the application of a first coating slip, said embossing unit resulting in at least one compressed and therewith depressed local surface that forms a distinctive mark on the paper/paperboard web, said depressed surface being filled at least partially with an applied first coating slip such that the thickness of the coating layer will be greater on said local surface than the thickness of the corresponding surrounding and outwardly lying first coating layer.

It will be evident from the aforegoing that the embossment takes place on the base paper and on the base paperboard or on surface sized base paper and surface sized base paperboard in accordance with this first embodiment of the inventive method.

In the case of a paperboard machine, the embossing unit may be positioned immediately downstream of the press section or between a pre-drying apparatus and a possible size press, or between a possible size press and an afterdrier. When the paperboard machine includes a glazing unit (calendar) the embossing unit may be positioned immediately upstream of or immediately downstream of the calendar, or may possibly be included in and form part of the calendar. Positions corresponding to these positions are also used in respect of a paper machine.

Subsequent to having embossed the material and therewith formed one or more depressions therein, the web of material can be wetted across its full width with an aqueous solution that contains an optical whitener in low concentration and/or some other chemical in low concentration at any chosen position downstream of the embossing apparatus. Any known optical whitener can be used (this also applies when admixing the agent with the coating slip). By a low or weak concentration of optical whitener is meant an addition of up to one part of whitener for each hundred parts of water. Polyvinyl alcohol can, for instance, be added in addition to the whitener, in an amount of up to three parts. Because it is essentially mobile water that is applied to the material, a significant amount of the aqueous solution will collect in the depressions that form part of the distinctive areas, and consequently a significant amount of optical whitener will also collect in these areas. The addition of optical whitener in the aforedescribed manner is so effective as to enable the addition of optical whitener to one or more coating slips to be excluded when desiring the distinctive areas or surfaces of the security product to be discernible when illuminated with a UV-lamp. In this case, a dye can be used instead of an optical whitener. This substance or this chemical can also be applied to the material in the form of an aqueous solution in low concentration. The high dye concentration in the distinctive areas or surfaces of the security product enables the dye concerned to be discerned by an observer when placing the product above a typical incandescent bulb.

An alternative method of producing security paper/paperboard is also proposed. In this alternative method, subsequent to a possible application of surface size there is applied congruently to a travelling paper/paperboard web a first coating slip which forms a first coating layer when dry, whereafter there is applied congruently a further coating slip in at least one stage. The method is characterised in that the paper/paperboard web with its first coating layer is caused to pass between an embossing roll and a counter-pressure roll, resulting in at least one compression and therewith one local depressed region that forms a distinctive mark on the first coating layer and the paper/paperboard web, said depression being filled at least partially with an applied second coating slip, so that the thickness of the second coating slip will be greater in the region of said local depression than the thickness of the corresponding surrounding and outwardly lying second coating layer.

In this case, the embossing unit is positioned downstream of the first coating unit, and also downstream of the following drying stage in the board machine or paper machine.

When viewing a cross-section of-a security board produced in accordance with the aforegoing, in the region of the distinctive mark and in the vicinity of said mark, and when the depression formed in the material has a substantially rectangular shape, at lest the upper part of the two vertical sides will be distinct, since the embossing tool is able to penetrate through a coating layer more easily than through a pulp fibre layer or a part of a pulp fibre layer.

The number of coating units downstream of the embossing unit is not restricted to one, but may be two or more.

As with the earlier case, the web may be wetted with an aqueous solution containing an optical whitener in low concentration and/or some other chemical in low concentration, at any position downstream of the embossing unit.

In this connection, as with the earlier described connection, the material may be coated in accordance with any known technique, such as by blade coating, rod coating, airbrush coating and film-press coating. The use of different techniques in different positions is also fully conceivable.

Advantages

One of the advantages afforded by the inventive security paper and security paperboard is that respective users of the paper and paperboard may obtain precisely the distinctive mark in the paper and paperboard that they desire. It is well known that different brand goods and also other products are subjected to undesired copying. It can be mentioned by way of example that certain products, such as cigarettes, pharmaceuticals and cosmetic products, are manufactured and brought into circulation commercially by persons other than the proprietor of the trademark or by someone to whom the proprietor has assigned the rights to the trademark. In the majority of cases it is not possible to determine whether the product is genuine or not, either by the retailer or by the purchaser, since the packages are identical in both instances. When the products are enclosed in packages comprised of the inventive security paperboard, it is much more difficult for pirate manufacturers to continue their activity. In the described case, the variation in sheen or lustre between the distinctive mark areas and remaining dominative surfaces of the packaging material can be utilised, by angling the package relative to a light source, daylight and/or ceiling lighting at the place of retail. The distinctive mark surfaces will be discerned much more clearly when an UV-lamp, either fixed or handheld, is directed onto the package, when the board contains an optical whitener and then in an elevated amount in the distinctive mark surfaces.

The production costs are minimised when the purchaser and/or the user of the inventive paper or paperboard allows the manufacturer to provide the product with, e.g., a special symbol of a general kind, i.e. of the kind used as recognition characters in many different contexts. In such case, it suffices for the paper and paperboard manufacturer to manufacture solely one embossing roll (or only a few embossing rolls) which can be installed almost once and for all in the machine.

Another advantage is that the distinctive mark in the paper and the paperboard is produced solely with the aid of an embossing unit and with the aid of the chemicals normally used in surface treatment processes, primarily paper coating processes, in other words no additional chemicals need be added, these additional chemicals possibly being expensive and/or detrimental to the environment.

One significant advantage afforded by the method according to the invention (and therewith also with respect to the cost of manufacturing the product to some degree) is that once having installed an embossing roll and a counter-pressure roll, if such a roll is not already found in the machine, the manufacture of the inventive security products can be commenced and terminated readily without necessitating a stop in operations with respect to the manufacture of conventional paper and conventional paperboard. This can be achieved, for instance, by pivotally mounting the embossing roll and by lifting the embossing roll away from the material web so as to pass free from said web, and then locking the embossing roll in a starting and rest position, for instance when wishing to terminate the manufacture of the inventive security product.

With respect to the inventive paper and when the paperboard according to the invention has a flat form and has not been converted, e.g., into a box or carton, the distinctive mark on the product can be readily seen by placing the material above a typical incandescent bulb, or by pointing the product onto a window in the daylight. Naturally, an UV-lamp can also be used like the aforedescribed angling method.

### DESCRIPTION OF THE DRAWINGS

FIG. 1 illustrates an inventive security paper applied above a typical incandescent bulb.

FIG. 2 is a schematic cross-sectional view of an inventive security paperboard, showing a distinctive mark and its nearest surroundings in accordance with one embodiment of the invention.

FIG. 3 is a schematic cross-sectional view of an inventive security paperboard, showing a distinctive mark and its nearest surroundings in accordance with another embodiment of the invention.

FIG. 4 illustrates schematically a part of a paperboard machine in which the inventive method is applied.

### BEST EMBODIMENT

The invention will now be described with reference to the drawings and also with reference to a number of trials concerning the manufacture of security paperboard in accordance with the invention.

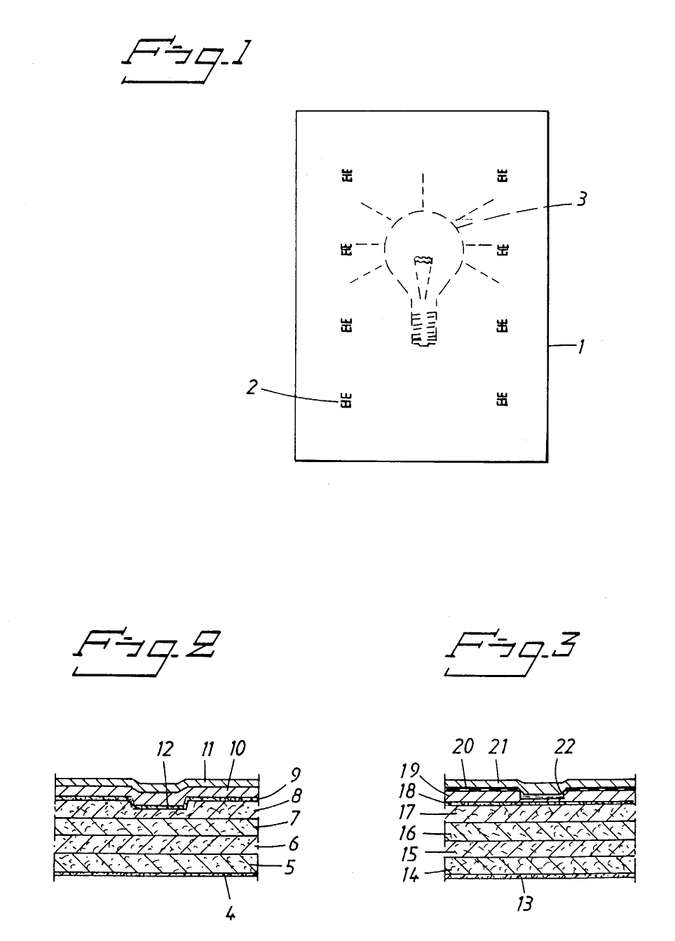

FIG. 1 shows an A4-sheet of an inventive security paper 1. The paper has eight distinctive marks 2 in the form of a special symbol, more particularly in an anchor design. The number of distinctive marks on each sheet of A4-paper may, of course, be smaller and greater than eight. The security paper 1 is shown placed above a typical incandescent bulb 3. The bulb 3 may be screwed into a socket and be free in other respects, or the bulb and the socket may be enclosed in a box that includes, for instance, a sheet of glass positioned above the lamp 3. When the security paper 1 is placed on the glass sheet, the eight distinctive marks 2 will appear as shown. The contrast between the eight distinctive marks 2 and the surface of the paper in general is normally not as pronounced as that shown in FIG. 1. (With regard to contrast, the symbol alters when copying the originally drawn symbol, for example). That a contrast is obtained, i.e. that the distinctive marks 2 appear in a darker tone than the remainder of the surface of the paper, is because the thickness of the local layer is greater than the thickness in general, i.e. than the thickness of the layer of the dominative surface of the paper. The mentioned layer is formed, e.g., by applying a traditional coating slip. As before mentioned such a slip may or may not contain an optical whitener. When the coating slip includes an optical whitener, a clear contrast between the distinctive marks and the remainder of the paper sheet can be discerned when there is used, instead of the conventional incandescent bulb in the aforedescribed device, a UV-lamp, either a fixed lamp or a hand carried lamp, by means of which the sheet can be illuminated from above or from one side.

It will be understood that the format of the security paper is not restricted to the aforesaid format and that said format can be varied within wide limits, determined by the customer, i.e. the purchaser of the security paper.

There are many areas of use for the described security paper. It can be inserted together with a given product into the package that surrounds the product. The paper may contain information relating to the goods or product concerned. It is preferred that the actual distinctive mark, i.e. a limited surface furthest out on the paper, is free form covering information. Compact discs (CDs) are one example of such products. Another example is an article of clothing of certain origin and certain design. The paper may also be used in computer manuals and as starting material in the manufacture of lottery tickets. The security paper may also be used beneficially in the manufacture of different types of labels, for instance labels for tins, jars or other packaging units that include certain pharmaceuticals and medicines. Information sheets from different companies sent to the general public or to specially targeted groups, where it is important to make clear that the information sheet, or document, comes from a certain company, may be based on the security paper in question. The inventive security paperboard may be an alternative to the inventive security paper in many of the aforedescribed areas of use, to which can be added the extensive packaging field, for instance where paperboard is converted to boxes, cartons and the like that contain, e.g., pharmaceuticals, cigarettes, perfumes, chocolate, and so on, or any other type of container. The inventive security paperboard can also be used in the manufacture of different types of folder and other publication material.

If the inventive security paper 1 in FIG. 1 were to be replaced with inventive security paperboard manufactured in a way similar to the manufacture of the security paper, the reproduction would be approximately the same.

FIG. 2 is a greatly enlarged, schematic cross-sectional view of security paperboard constructed in accordance with a first embodiment of the invention, showing a distinctive mark and its closest surrounds.

The following is noted when the cross-section is studied from beneath and upwards. The undermost layer 4 is comprised of a surface size layer. The base paperboard is comprised of four pulp fibre layers, these being a bottom layer 5, two midway layers 6 and 7, and a top layer 8. A further surface size layer 9 is provided on the top layer 8. There then follows a first coating layer 10, on which a second coating layer 11 is formed. In the illustrated case, the base paperboard and its surface size layer 9 have been embossed to provide a depression 12. As will be seen, the coating layer 10 is thicker at the depressed region 12 than at surrounding sides of the depression. The upper coating layer 11 is also slightly thicker in the region 12 than on surrounding sides of the depression.

The total thickness of the coating layers in the region 12 is significantly greater than the thickness of the coating layers outwardly of and surrounding said region 12. This greater thickness of the material in the described positions means that the region 12 will show up in a darker colour than the colour shown by the surrounding material when the paperboard is placed above a conventional incandescent bulb in accordance with the FIG. 1 illustration, for instance.

Despite the thickness of the coating layer in the region 12 being greater than the thickness of the surrounding coating layer, a small depression will still remain in the material as seen totally in the region 12. This fact also contributes towards making the region 12 perceivable, i.e. towards providing a distinctive mark or feature of some kind. This depression in the material can also be sensed by running a finger or fingers on one hand along the surface of the security paperboard.

The security paperboard shown in FIG. 2 has two surface size layers 4 and 9. As mentioned in the aforegoing, these layers are not absolutely necessary. The board in FIG. 2 also includes four pulp fibre layers. As previously mentioned, the number of such layers may be varied. For instance, five pulp fibre layers are just as usual as four such layers.

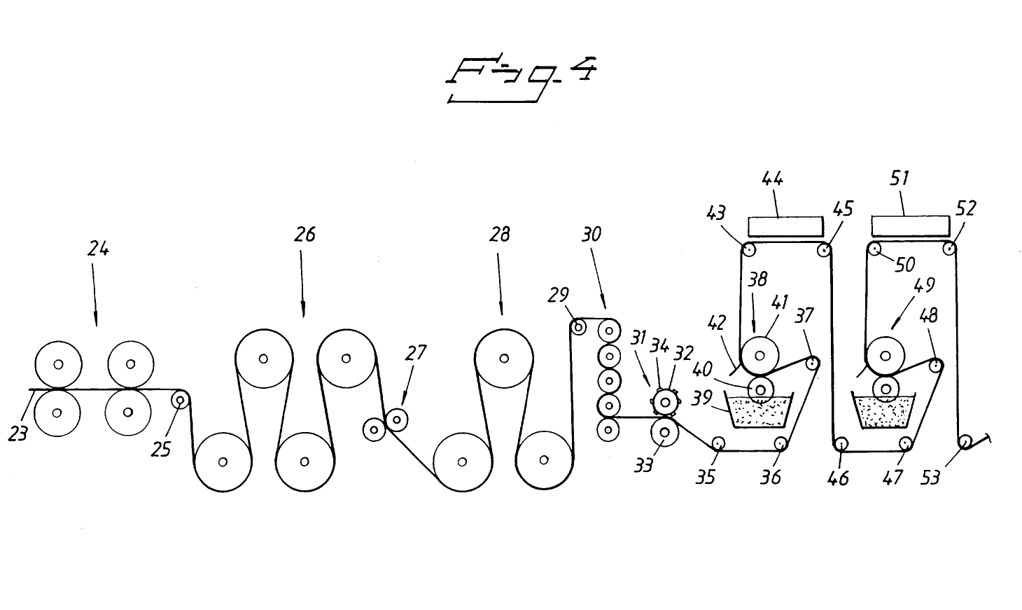

FIG. 3 is a greatly enlarged, schematic cross-sectional view of a security paperboard according to a second embodiment of the invention, and shows a distinctive mark and its nearest surroundings.

The following will be noted when studying the cross-section from beneath and upwards. The lowermost layer 13 is comprised of a surface size layer. There then follows an essentially intact base board that includes a bottom layer of pulp fibres 14, two midway layers 15 and 16, and a top layer 17. A surface size layer 18 is located on top of the top layer 17. There then follows a first coating layer 19, an outermost thin film of optical whitener and polyvinyl alcohol 20 and a second coating layer 21. In the illustrated case, the base board 14-17 was provided with a surface size layer 18 and a first coating layer 19 before the paperboard was embossed to provide a depression 22 in the paperboard material. The material that was compressed primarily was the first coating layer 19, and therewith also the surface size layer 18. Although not shown in the figure, the uppermost pulp fibre layer 17 may also be compressed to some extent.

The outermost thin film of optical whitener and polyvinyl alcohol 20 is at least two times as thick in the depression 22, which forms a distinctive mark, as the thickness on respective sides of this region. The thickness of the second coating layer 21 is also much thicker in the depressed region, i.e. in the region 22, than on respective sides of this region. When the second coating layer includes an optical whitener, the pronounced higher quantity of optical whitener in the region 22 than in the surface area surrounding said region will be discerned as a bright or white shining area when illuminated with the aid of a UV-lamp, therewith enabling the surfaces bearing the distinctive marks to be easily distinguished from the remainder of the paperboard surface. Although scarcely visible, the region 22 also in this case includes a depression in the finished material.

FIG. 4 illustrates schematically the later half of a paperboard machine. Those parts of the machine not shown in the figure are, inter alia, the inlet section and the process of forming the various layers of fibre pulp in the paperboard machine. The figure illustration commences with passing the formed paperboard web 23 through a press section 24, over a guide roller 25, and into a pre-drying section 26. The paperboard web is passed from the pre-drier to a size press 27, for instance of the kind designated SYM-SIZER, where a layer of surface size is applied to the upper side of the paperboard web. The paperboard web is then passed to an afterdrier 28 and from there to a calendar 30 via a guide roller 29. The calendar typically comprises a large number of hard metal rolls, for instance steel rolls, arranged one above the other to form a plurality of roll nips.

The paperboard web is passed from the calendar 30 to an embossing unit 31 which comprises an embossing roll 32 and a smooth counter-pressure roll 33. Both rolls may be made of metal and therewith hard. The bottom roll is normally coated with rubber. Rubber coatings of varying degrees of hardness are available. The upper roll 32, normally made of metal, includes several projections 34 disposed in the form of a distinctive mark. These projections 34 have been enlarged in the figure, so as to enable them to be seen. The projections 34 penetrate into the paperboard web and compress primarily the layer of surface size and the top sheet or layer of the paperboard web, so as to form a plurality of embossed surfaces or depressions. The embossed web of material is passed to a first blade coating unit 38, via guide rollers 35, 36 and 37. This unit 38 is comprised of a container or tank 39 that contains a coating slip, an applicating roll 40, a counter-pressure roll 41 and a coating blade 42.

The applicating roll 40 takes the coating slip from the tank 39 and applies it to that side of the paperboard web on which the embossments and depressions forming the distinctive marks are present. The disappearing and final thickness of the applied coating is determined by the coating blade 42, which lies in abutment with the newly applied coating slip. More coating slip is retained in the depressions than on the remainder of the paperboard web.

The coated paperboard web is moved in beneath an IR-drier 44, via a guide roller 43, where the coating slip is dried to form a coating layer. The board web is then passed to a second blade coating unit 49, via guide rollers 45, 46, 47, 48, where the paperboard web carrying its first coating layer is provided with a second coating slip in a similar way as in the first coating unit 38. The double coated web is then passed in beneath a second IR-drier 51, via guide roller 50, where the second coating slip is dried to form a second coating layer. The finished paperboard web is then, via the guide rollers 52 and 53, passed to a reeling unit or to a conversion unit, where the paperboard web is converted into free sheets of given size (not shown in the figure).

The security paperboard produced in the aforedescribed manner in accordance with the invention has great similarity to the board illustrated in FIG. 2.

The projections 34 on the embossing roll 32 are normally produced by an engraving process, i.e. a process in which a given thickness of the diminutive surface of the cylindrical roll is, for example, milled away and by leaving certain surfaces untreated and thereby form the projections in question. These projections can have any chosen form, which determines the form and the appearance of the distinctive mark chosen to enable the paperboard to be identified. The embossing rolls can alternatively be produced or prepared in other ways. For instance, adhesive tapes that have the form of the distinctive mark can be applied to a smooth roll at a desired interspacing. The thickness of the tape determines the depth of embossment to some extent. This latter is also determined by the nip pressure between the two rolls in the embossing unit 31. When the paperboard machine includes a calendar in accordance with the FIG. 4 illustration, the calendar treatment, for instance the pressure in the calendar, also have an influence on the subsequent embossment of the paperboard web.

### EXAMPLE 1

A base paperboard comprising four layers with a total weight per unit area, or grammage, of 200 g/m², was manufactured in a paperboard mill. Seen totally, the base paperboard was comprised of 40% birch sulphate pulp having a brightness of 91% ISO, measured according to ISO-brightness 2470, and 30% pine sulphate pulp having a brightness of 91% ISO, and 30% pulped broke which had a brightness substantially in accordance with the aforegoing. Each layer contained the additive chemicals potato starch, hydrofobising agent in the form of alkyl ketene dimers, and retention agents in the form of polymers and bentonite. Alun and sodium hydrogen carbonate were also added. The paperboard was provided on each side with a layer of surface size corresponding to an applying amount of 4 g/m². The surface size comprised

100 parts pigment (mixture of kaolin clay and calcium carbonate)

40 parts maize starch

10 parts thickener (carboxymethyl cellulose)

1.5 parts additive chemicals (hardener and wax)

This base paperboard was taken in roll form to a pilot machine affiliated with the paperboard mill. The pilot machine included paperboard calendering and coating facilities with the use of different techniques. The upper side, or print side, of the paperboard was embossed in one of the calendar nips defined between a hard metal roll and a rubber-coated roll having a surface hardness of 10 p&j. Anchor symbols, similar to those shown in FIG. 1, having a thickness of 0.050 mm and produced from vinyl plastic, were firmly stuck to the hard metal roll. The line pressure in the nip across the 53 cm wide paperboard web was 37 kN/m, which gave an impression depth or depression in the paperboard of about 0.024 mm. The paperboard web moved at a speed of 250 meters per minute in the embossing process.

The paperboard was then coated with two coating layers on the same side of the paperboard as that newly embossed. The blade coating unit in the pilot machine was used in both coating processes. The first coating slip, or pre-coating slip, comprised

100 parts pigment (calcium carbonate)

15 parts binder (styrene acrylate latex)

2.4 parts polyvinyl alcohol (PVA)

0.6 parts optical whitener (in the form of Tinopal ABP-Z)

1 part additive chemical (thickener, hardener and pH-adjuster).

The coating slip had a dry solids content of 65% and was applied to the dominating surface of the paperboard in a quantity corresponding to 10 grams/m², whereas the amount applied in the embossed patterns, i.e. the anchor symbols, corresponded to 20 g/m². The depth of the depression on the surfaces carrying the distinctive marks was decreased to about 0.018 mm by the pre-coating. The paperboard was coated at a speed of 350 meters/minute. Because the coating slip contained an optical whitener, and because more slip was contained in the embossed surfaces, i.e. the depressions, these surfaces were whiter in colour than the remainder of the coated surface. The second coating slip, or top coating slip, comprised

100 parts pigment (kaolin clay and calcium carbonate)

20 parts binder (styrene acrylate latex)

1 part additive chemicals (thickener, hardener, blue nuancing dye and pH-adjuster)

The coating slip had a dry solids content of 65% and was applied to the dominant surface of the paperboard in an amount corresponding to 12 g/m², while the amount applied in the embossed patterns, i.e. the anchor symbol depressions, corresponded to 17 g/m². The top coating caused the depressions in the surfaces carrying the distinctive marks to decrease to about 0.012 mm. The coating slip was applied at a speed of 350 meter/minute.

It will be evident from the above list that the top coating slip contained no optical whitener. Even though an optical whitener was used in solely the bottom or first coating layer and then in an elevated quantity in the distinctive mark surfaces, these surfaces were still discerned by a viewer as being lighter or whiter than the remainder of the paperboard surface when the paperboard was illuminated with ultraviolet light. This despite that an increased layer thickness on the distinctive mark surfaces in relation to the remainder of the layer with regard to the second or top coating layer inhibits this effect and acts in an opposite sense per se. When this security paperboard is placed above a conventional incandescent lamp, the opposite takes place, i.e. the distinctive mark surfaces are darker than the remainder of the paperboard.

### EXAMPLE 2

This trial was essentially a repetition of the trial described in example 1, but with the difference that the base paperboard was first provided with a first coating layer and then embossed. The line pressure in the embossing process, i.e. in the calendar nip, was kept lower than the line pressure in the first trial, and was 18 kN/m, which resulted in depressions in the pre-coated paperboard of about 0.036 mm. The second coating layer was applied to the embossed patterns, i.e. the anchor symbols, in an amount corresponding to 22 g/m². Subsequent to applying the second coating layer, the depressions had a depth of 0.022 mm. This trial resulted in a security paperboard that has similar properties to the security paperboard produced in accordance with example 1.

### EXAMPLE 3

The base paperboard was embossed in accordance with example 1. The depth of the embossment in the material was 0.025 mm in this case. The embossed base paperboard was pre-coated in the same way as in example 1 and with the same type of coating slip, although with the difference that the amount of optical whitener was reduced to 0.1 parts and that the amount of polyvinyl alcohol was reduced to 0.4 parts. The coating slip was applied to the distinctive mark surfaces in an amount corresponding to 21 g/m², causing the depth of the depressions to decrease to 0.020 mm.

An aqueous solution containing the following ingredients was prepared

100 parts water

0.6 parts optical whitener of the earlier described kind

2.4 parts polyvinyl alcohol.

This aqueous solution was applied to the pre-coated board in a film press, at a speed of 350 meters/minute.

A top coating was then applied to the material completely in accordance with example 1. The coating slip was applied to the distinctive mark surface in a quantity corresponding to 16 g/m², wherewith the depth of the depressions decreased to 0.014 mm.

The described method of producing security paperboard in accordance with the invention resulted in the distinctive mark surfaces containing much more optical whitener than the remainder of the paperboard surface, wherewith the distinctive mark surfaces could be seen clearly under UV-lighting for instance, despite the covering top coating layer.

1. Security paper/paperboard that includes one or more layers of pulp fibre forming a base paper/paperboard, together with one or more surface treatment layers congruent with the base paper/paperboard on at least one side thereof, wherein at least one such surface treatment layer forms a part of at least one local deviation in the form of a distinctive mark, characterised in that the local deviation includes locally compressed material plus a local surface treatment layer whose thickness exceeds the thickness of the corresponding surrounding and outwardly lying surface treatment layer.

2. Security paper/paperboard according to claim 1, characterised in that the distinctive mark has the form of a company name and/or a company logotype and/or a trademark and/or some other special symbol.

3. Security paper/paperboard according to claims 1-2, characterised in that the locally compressed material is comprised of the base paper/paperboard, optionally plus a layer of surface size.

4. Security paper/paperboard according to claim 3, characterised in that the base paper/paperboard and an optional layer of surface size is/are covered by a coating layer that has a locally increased thickness.

5. Security paperboard according to claim 4, characterised in that the increased thickness of the local coating layer does not fully compensate the reduced thickness of the underlying material caused by said compression.

6. Security paper/paperboard according to claim 4, characterised in that the increased thickness of the local coating layer fully compensates the reduced thickness of the underlying material caused by said compression.

7. Security paper/paperboard according to claim 3, characterised in that the base paper/paperboard and an optional layer of surface size is/are covered of two or more coating layers, of which at lest the undermost coating layer has a locally increased thickness.

8. Security paper/paperboard according to claims 1-2, characterised in that the locally compressed material is comprised of said base paper/paperboard possibly together with a layer of surface size and a first coating layer.

9. Security paper/paperboard according to claim 8, characterised in that the base paper/paperboard possibly plus a layer of surface size and a first coating layer is/are covered with a further coating layer that has a locally increased thickness.

10. Security paper/paperboard according to claim 8, characterised in that the base paper/paperboard possibly plus a layer of surface size and a first coating layer is/are covered with two or more further coating layers, of which at least the undermost layer of said further coating layers has a locally increased thickness.

11. Security paper/paperboard according to claims 1-10, characterised in that the upper delimiting surface of the compressed material has a profile that is disparate from a substantially horizontal line.

12. Security paperboard according to claims 1-3 and 7, characterised in that the base paperboard is comprised of four layers of pulp fibre, a bottom layer, two midway layers, and a top layer, surrounded by a layer of surface size on both the bottom side and the upper side, which is locally compressed from the upper side; and in that the upper side of the base board is covered with two coating layers, of which either only the lower coating layer or both coating layers has/have a locally increased thickness.

13. A method of manufacturing security paper/paperboard, wherein a travelling paper/paperboard web, optionally after having applied surface size thereto, is coated congruently with coating slip in at least one stage, characterised in that the travelling paper/paperboard web is caused to pass between an embossing roll and a counter-pressure roll forming an embossing unit in any position whatsoever prior to applying the first coating slip, said embossing unit leading to at least one compressed, and thereby depressed, local surface which forms a distinctive mark on the paper/paperboard web, wherein said depression is filled at least partially with said applied first coating slip such that the thickness of the coating layer on said local surface will be greater than the thickness of the corresponding surrounding and outwardly lying first coating layer.

14. A method according to claim 13, characterised in that a travelling paperboard web is caused to pass through an embossing unit situated immediately downstream of a press section of a paperboard machine.

15. A method according to claim 13, characterised in that a travelling paperboard web is caused to pass through an embossing unit situated between a pre-drier and a possible size press in a paperboard machine.

16. A method according to claim 13, characterised in that a travelling paperboard web is caused to pass through an embossing unit situated between a possible size press and an afterdrier in a paperboard machine.

17. A method according to claim 13, characterised in that a travelling paperboard web is caused to pass through an embossing unit situated immediately upstream or immediately downstream of a glazing unit that is included in a paperboard machine or that forms part of the embossing unit.

18. A method according to claim 13-17, characterised in that a travelling paperboard web with a depressed local surface is wetted with an aqueous solution containing an optical whitener in low concentration and/or some other chemical in low concentration, either prior to applying the first coating slip or subsequent to applying said first coating slip.

19. A method of producing security paper/paperboard wherein, after the possible application of surface size, a first coating slip is applied congruently to a travelling paper/paperboard web so as to form a first coating layer and subsequent to drying said layer, a further coating slip is applied congruently to said paper/paperboard web in at least one stage,
characterised in that the paper/paperboard web with its first coating layer is caused to pass between an embossment roll and a counter-pressure roll leading to at least one compressed, and thereby depressed, local surface forming a distinctive mark on the first coating layer and on the paper/paperboard web, wherein said depression is at least partially filled by the second coating slip applied to said web, such that the thickness of the second coating layer on said local surface will be greater than the thickness of the corresponding surrounding and ourwardly lying second coating layer.

20. A method according to claim 19, characterised by wetting the travelling paper/paperboard web with its first coating layer and its depressed local surface with an aqueous solution that contains an optical whitener in low concentration and/or some other chemical in low concentration, immediately subsequent to said embossing process or subsequent to applying said second coating slip.
